(19) United States
(12) Patent Application Publication
(10) Pub. No.: US 2002/0033590 A1
(43) Pub. Date: Mar. 21, 2002

(54) Air bag diffusion device

(76) Inventor: Rick Adkisson, Mesa, AZ (US)

Correspondence Address: Robert J. Depke, MAYER, BROWN & PLATT, 190 South LaSalle Street, Chicago, IL, 60603, US

(21) Appl. No.: 09/920,063

(22) Filed: Jul. 31, 2001

Related U.S. Application Data
(62) Division of application No. 09/525,395, filed on Mar. 15, 2000, now abandoned.

(51) Int. Cl. B60R 21/20

(52) U.S. Cl. 280/728.3; 280/728.1

(57) ABSTRACT

An airbag that is preferably deployed over and/or around a top surface of a seatbelt has a deployment mechanism that includes a fabric screen, flap or bladder which may be located over one or more high pressure gas diffusion heads. The fabric screen, flap or bladder includes one or more openings that allow pressurized gas to pass therethrough and fill an airbag during deployment. Advantageously, the fabric screen, flap or bladder does not interfere with the deployment of the airbag and also may be used to alter the deployment characteristics of the airbag. A further feature and advantage of the fabric screen, flap or bladder which is preferably located over one or more diffusion heads in accordance with the present invention is that the fabric screen, flap or bladder aids in the diffusion of the pressurized gas into the airbag chamber or chambers thereby allowing the pressurized gas to rapidly fill the airbag but also eliminating any potential for damage to the airbag material from the rapidly expanding pressurized gas.

### BACKGROUND OF THE INVENTION

1. Field of the Invention

The present invention is generally directed to the field of automatic air bag deployment systems. More specifically, the present invention is directed to an air bag diffusion device having at least one diffusion head that is covered by a fabric screen, flap or bladder which readily allows pressurized gas to pass there through and fill the air bag with gas during deployment while also protecting the air bag from damage caused by the rapidly expanding pressurized gas. The device disclosed herein also includes an air bag having a plurality of chambers that open sequentially.

2. Description of the Related Art

Air bag deployment systems are generally known in the field and have been widely used in the automobile industry. The majority of these deployment mechanisms employ a cover which separates from a top of a housing that encloses an air bag prior to deployment. More recently, air bags have been suggested for use in aircraft where they will be deployed directly from seat belts in front of passengers.

In aircraft, where air bags will be deployed from seat belt locations, there are special issues related to deployment of the air bags which have not been addressed in prior air bag deployment system designs. Specifically, when air bags are located on seat belts, the deployment structures and the stored air bag prior to deployment must remain somewhat flexible. The air bags stored on seat belt locations must also typically be stored in a significantly smaller package than is usually the case for steering wheel locations or other compartments within automobiles. Furthermore, the deployment mechanism and bag storage must not interfere with air bag deployment during a collision or other impact event.

Regardless of the storage location, the air bag must deploy with minimum resistance and must not cause injury to an occupant during deployment of the air bag. The deployment structures must also not shred the fabric of the air bag during deployment while also allowing the overall package to be tamper resistant yet aesthetically pleasing. The air bag deployment mechanism must satisfy each of these requirements while also providing satisfactory deployment an air bag that has packed more tightly than other conventional air bags.

Accordingly, there remains a need in the art for improved air bag deployment mechanisms which satisfy each of the requirements set forth above for air bags stored in seat belt locations. The inventors of the present application have discovered an air bag deployment mechanism for an air bag located on a seat belt that satisfies each of these requirements.

Additionally, the inventors of the present application have identified an airbag having a plurality of chambers that open sequentially during deployment. It will be apparent to those skilled in the art that the devices described herein satisfy each of these requirements in light of the following Summary and Detailed Description of the presently preferred embodiments.

### SUMMARY OF THE INVENTION

In accordance with the present invention, an air bag that is preferably deployed over and/or around a top surface of a seatbelt has a deployment mechanism that includes a fabric screen, flap or bladder which may be located over one or more high pressure gas diffusion heads. The fabric screen, flap or bladder includes one or more openings that allow pressurized gas to pass there through and fill an air bag during deployment.

Advantageously, the fabric screen, flap or bladder does not interfere with the deployment of the air bag and also may be used to alter the deployment characteristics of the air bag. A further feature and advantage of the fabric screen, flap or bladder which is preferably located over one or more diffusion heads in accordance with the present invention is that the fabric screen, flap or bladder aids in the diffusion of the pressurized gas into the air bag chamber or chambers thereby allowing the pressurized gas to rapidly fill the air bag but also eliminating any potential for damage to the air bag material from the rapidly expanding pressurized gas. The fabric screen, flap or bladder essentially acts as a buffer to allow the rapidly expanding gas to fill the air bag while also eliminating any potential for harm to the air bag.

The fabric screen, flap or bladder is preferably comprised of a flexible sheet of durable material such as, for example, kevlar or nylon 66. The selection of the flexible durable material ensures that the expanding gas will easily pass into the air bag but that it will not damage the airbag material.

In one exemplary embodiment of the invention, at least one flap of durable material acts as a fabric screen and is preferably formed over a high pressure gas diffusion head. The flap of material acts as a screen to shield the airbag material from potential harm arising out of the force of the rapidly expanding gas. The flap may be secured and/or located to alter the way in which gas fills the airbag during deployment. Specifically, the flap may be used to alter high pressure gas flow paths through the selective placement of the flaps thereby directing the pressurized gas into desired locations within the airbag. Regardless of the placement of the flap, the flap acts as a buffer to prevent the rapidly expanding gas from damaging the airbag.

In an alternate exemplary embodiment, a bladder is preferably placed around a high pressure gas diffusion head located within the cavity of an airbag. The bladder desirable has a plurality of holes in a top surface that allow pressurized gas from the diffusion head to pass therethrough and rapidly fill the airbag. The bladder acts as a buffer and allows the gas to rapidly fill the airbag without damaging the airbag material.

In a further alternate embodiment of the invention, the holes in the bladder material may have a alterations in their physical size and/or location that may be used to alter the bag deployment characteristics. For example, more holes on one side of the bladder or larger holes on a given side of the bladder will cause the corresponding side of the airbag to fill more rapidly than a side of the airbag having fewer and/or smaller holes in the corresponding portions of the underlying bladder material. The bladder is also preferably formed of kevlar or nylon 66 to ensure durability while also providing a flexible structure that will not significantly interfere with the deployment process.

In yet a further alternate embodiment, a flexible flap of durable material is preferably formed over a high-pressure gas diffusion head. The flexible flap includes a plurality of holes in a top surface. The holes in the top surface of this design may be used to alter the deployment characteristics of the airbag.

In another alternate exemplary embodiment of the present invention, an airbag includes a plurality of chambers that open sequentially during deployment of the airbag. Those skilled in the art will recognize that the sequential deployment of airbags in the manner disclosed herein may be used to alter the dynamic effect of the expanding bag on occupants.

Other objects and advantages of the present invention will be apparent from the following Detailed Description of the preferred embodiments.

### BRIEF DESCRIPTION OF THE DRAWINGS

FIG. 1 illustrates a first preferred embodiment of the present invention;

FIG. 2 illustrates a side view of the embodiment of the present invention set forth in FIG. 1;

FIG. 3 illustrates a further embodiment of the present invention wherein a bladder surrounds a diffusion head.

FIG. 4 illustrates a side view of the embodiment illustrated in FIG. 3;

FIG. 5 illustrates an airbag having multiple chambers;

FIG. 6 is a side view illustration of the temporary barrier between bag chambers.

### DETAILED DESCRIPTION OF THE PREFERRED EMBODIMENTS

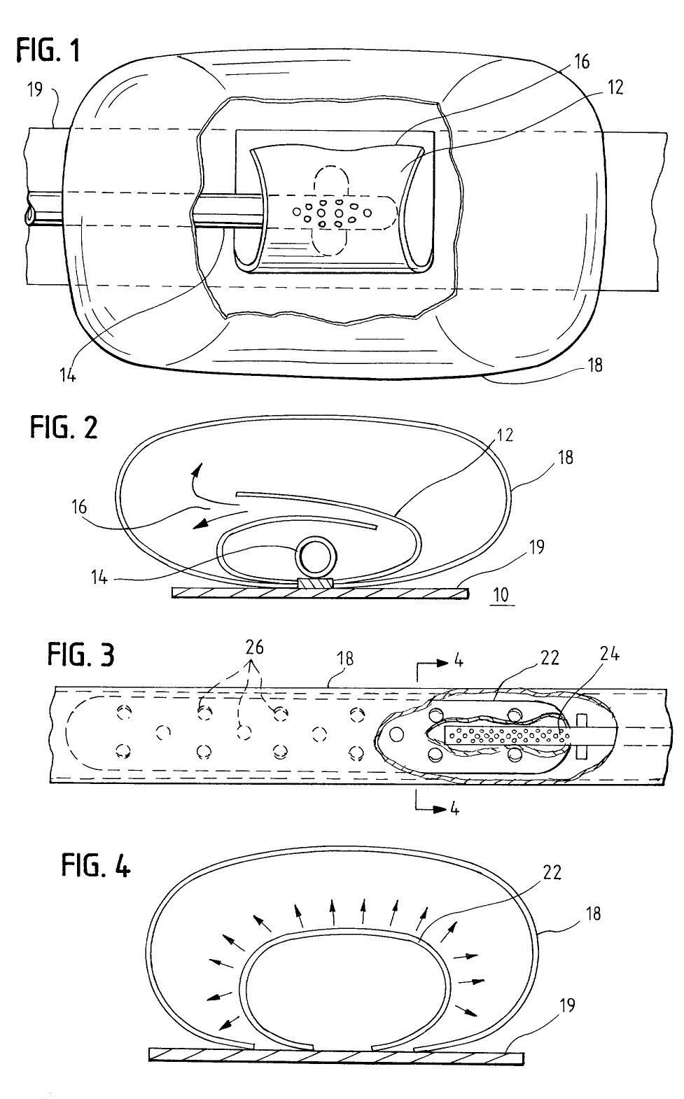

An exemplary airbag cover of the present invention is shown generally in FIG. 1 at 10. As shown in FIG. 1, an airbag that is preferably deployed over and/or around a top surface of a seatbelt has a deployment mechanism that includes a fabric screen or flap 12 which may be located over one or more high pressure gas diffusion heads 14. The fabric screen or flap 12 includes one or more openings 16 that allow pressurized gas to pass therethrough and fill an airbag 18 during deployment.

Advantageously, the fabric screen or flap 12 does not interfere with the deployment of the airbag 18 and also may be used to alter the deployment characteristics of the airbag 18. A further feature and advantage of the fabric screen or flap 12 is that the fabric or flap aids in the diffusion of the pressurized gas into the airbag chamber or chambers thereby allowing the pressurized gas to rapidly fill the airbag but also eliminating any potential for damage to the airbag material 18 from the rapidly expanding pressurized gas. The fabric screen or flap essentially acts as a buffer to allow the rapidly expanding gas to fill the airbag 18 while also eliminating any potential for harm to the airbag 18.

The fabric screen or flap 12 is preferably comprised of a flexible sheet of durable material such as, for example, kevlar or nylon 66. The selection of the flexible durable material ensures that the expanding gas will easily pass into the airbag but that it will not damage the airbag material. The fabric screen or flap 12 may be directly secured to the underlying seat belt 19 on which it is secured.

The flap of material 12 acts as a screen to shield the airbag material from potential harm arising out of the force of the rapidly expanding gas. The flap 12 may be secured and/or located to alter the way in which gas fills the airbag during deployment. Specifically, the flap 12 may be used to alter high pressure gas flow paths through the selective placement of the flap or flaps thereby directing the pressurized gas into desired locations within the airbag.

For example, as shown in FIG. 2, the side view of the flap 12 clearly shows the path of gas discharged from the diffusion head 14 through the flap 12. Those skilled in the art will readily recognize that the flap or screen may be connected to the underlying belt or to itself in such a way that the flow path of gas into the bag may be altered. The side view illustration of FIG. 2 shows how gas discharges into the airbag 18 through unsecured portions of the flap material. However, by securing portions of the flap 12 to itself or to the underlying seat belt or other structure, the attached portions will not allow gas to pass therethrough and thus can be used to alter the path of gas into the bag through unattached portions of the flap. Regardless of the placement of the flap, the flap acts as a buffer to prevent the rapidly expanding gas from damaging the airbag.

In an alternate exemplary embodiment illustrated in FIG. 3, a bladder 22 is preferably placed around a high pressure gas diffusion head 24 located within the cavity of an airbag. The bladder 22 desirably has a plurality of holes 26 in a top surface that allow pressurized gas from the diffusion head 24 to pass therethrough and rapidly fill the airbag. The bladder acts as a buffer and allows the gas to rapidly fill the airbag without damaging the airbag material.

In FIG. 3, the holes are shown as being placed substantially uniformly throughout the bladder. In a further alternate exemplary embodiment of the invention, the holes 26 in the bladder material 22 may have a alterations in their physical size and/or location that may be used to alter the bag deployment characteristics. For example, more holes on one side of the bladder or larger holes on a given side of the bladder will cause the corresponding side of the airbag to fill more rapidly than a side of the airbag having fewer and/or smaller holes in the corresponding portions of the underlying bladder material. The alteration of bag deployment may be used as known in the art to alter the dynamics of interaction between an occupant and the airbag during deployment. The bladder is also preferably formed of kevlar or nylon 66 to ensure durability while also providing a flexible structure that will not significantly interfere with the deployment process.

FIG. 4 is a side view illustration of the airbag deployment structure shown in FIG. 3. FIG. 4 illustrates the characteristics of gas flow from bladder through the holes into the airbag during deployment.

In yet a further alternate embodiment, a flexible flap or fabric screen of durable material is preferably formed over a high- pressure gas diffusion head and the flexible flap or fabric screen includes a plurality of holes in a top surface. This embodiment is essentially a combination of the bladder embodiment with the embodiment of FIG. 1. In this embodiment, both the holes in the top surface of this design and the selective locations of the flap openings may be used to alter the deployment characteristics of the airbag.

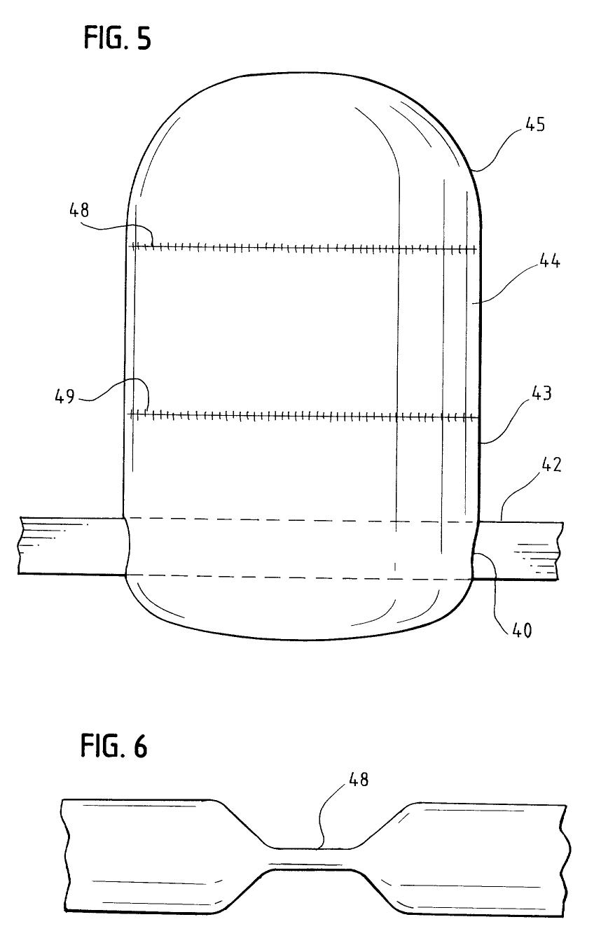

FIG. 5 illustrates yet a further alternate embodiment of the present invention wherein an airbag 40 is mounted on a seat belt 42. The airbag 40 is comprised of three distinct chambers 43, 44, and 45. The chambers 43, 44, and 45 open sequentially during deployment of the airbag. In order to accomplish this sequential opening of the airbag, each of the chambers are separated from each other by ultrasonic weld seams 48, 49 that are formed preferably using an amplitude for the ultrasonic welding that allows the material to disengage or un-weld at a specified pressure such that there is no damage to the airbag integrity.

As a result, during deployment, as high pressure gas expands into the first chamber 43, the pressure within the first chamber builds until the pressure is great enough to cause a force on the separating seam that causes the seam to break. The break of the separating seal allows the second chamber 44 to also fill with pressurized gas. This is repeated until each of the three chambers have been filled with gas.

FIG. 6 illustrates one of the separating seams 48, 49 that is formed between two chambers. As noted above, the separating seam which is desirably formed by ultrasonic welding breaks prior to the time at which the first chamber is fully pressurized. The use of multiple chambers allows the airbag to fill at different rates and intervals to allow the airbag to apply force to different parts of an occupant at different times. Additionally, pressurizing the lowest chamber first, allows the airbag to position and center more rapidly on the belt assembly.

During deployment of such an airbag, the gas generating system pressurizes the first chamber thereby initially allowing the airbag to acquire the required position and center on the occupant. When the first chamber pressurizes, it allows the airbag to work on the occupant's mid-section, thereby restraining the occupant into the seat.

Thereafter, the pressure in the first chamber overcomes the first seam and it breaks allowing the second chamber to fill as well. The first and second chambers pressurize, and allow the airbag to work on the occupant's mid-section and chest, thereby arresting the forward motion of the occupant. Finally, the second seam breaks as the pressure increases within the first and second chambers. The entire bag then fills with gas allowing the bag airbag to perform work on the head, chest and mid-section of the occupant and to cushion the occupant from an impact.

The present invention has been described with respect to the exemplary embodiments and is subject to many variations and modifications that nevertheless fall within the spirit and scope of the appended claims.

We claim:

1. An airbag comprising:
at least one sheet of flexible material formed over a diffusion head within an airbag;
said sheet of flexible material forming at least one opening into a cavity of an airbag.

2. The airbag of claim 1, wherein the sheet of flexible material is secured to a seatbelt in a plurality of locations.

3. The airbag of claim 1, wherein a plurality of first portions of the sheet of flexible material are secured to a corresponding plurality of second portions of the sheet of flexible material.

4. The airbag of claim 2, further comprising a plurality of openings in a top surface of the sheet of flexible material.

5. The airbag of claim 3, further comprising a plurality of openings in a top surface of the sheet of flexible material.

6. The airbag of claim 4, where in the plurality of holes are located substantially uniformly on the top surface.

7. The airbag of claim 5, wherein the plurality of holes are located substantially uniformly on the top surface.

8. The airbag of claim 4, wherein a first region of the top surface has a greater number of openings than a second region of the top surface.

9. The airbag of claim 5, wherein a first region of the top surface has a greater number of openings than a second region of the top surface.

10 An airbag comprising:
at least one bladder formed around over a diffusion head within an airbag; said bladder having a plurality of openings into a cavity of an airbag.

11. The airbag of claim 10, wherein the bladder is secured to a seatbelt in a plurality of locations.

12. The airbag of claim 1 1, wherein the plurality of openings are in a top surface of the bladder.

13. The airbag of claim 12, wherein the plurality of holes are located substantially uniformly on the top surface.

14. The airbag of claim 12, wherein a first region of the top surface has a greater number of openings than a second region of the top surface.

15. An airbag comprising:
a cavity;
said cavity having at least two chambers separated by a temporary seam.
